(19) United States
(12) Patent Application Publication
(10) Pub. No.: US 2001/0034003 A1
(43) Pub. Date: Oct. 25, 2001

(54) Method and device for making the fired-material discharge stream from a rotary kiln to a cooler more uniform

(76) Inventor: Hans-Peter Wellmann, Buxtehude (DE)

Correspondence Address: ALIX YALE & RISTAS LLP, 750 MAIN STREET, SUITE 600, HARTFORD, CT, 06103

(21) Appl. No.: 09/840,585

(22) Filed: Apr. 23, 2001

(30) Foreign Application Priority Data
Apr. 25, 2000 (EP) 00108787.3

(51) Int. Cl. F27B 7/14

(52) U.S. Cl. 432/118; 432/113; 432/117

(57) ABSTRACT

A method or an arrangement for making the fired-material discharge stream from a rotary kiln more uniform upstream of a cooler is distinguished by the fact that at least some of the fired material is conveyed out of the coarse-material discharge region (5) toward the fine-material discharge region (4) and/or at least some of the fired material is conveyed out of the fine-material discharge region (5) toward the coarse-material discharge region (5) before it reaches the cooler.

A characteristic feature of the discharge of fired material, for example cement clinker, at the outlet end of a rotary kiln is that the coarse material is discharged in the lower region of the outlet, whereas the fine material is discharged in that region of the outlet which rises during rotation. If the discharge stream is considered over its width, it will be established that the coarse material is to be found predominantly on one side and the fine material is to be found substantially on the other side. In the present text, that region of the discharge stream which contains predominantly the coarse material is referred to as the coarse-material discharge region, and the other part, which contains predominantly fine material, is referred to as the fine-material discharge region. There is no precise delineation between these regions.

The uneven distribution of the grains in the discharge stream may have adverse effects on the way in which the downstream cooler operates. If this is a grate cooler, the result is different conditions for the heat exchange and instability when the cooler is operating.

Therefore, it has been proposed (DE-A 19546174) to fit a ring of blades on the outlet edge of the rotary kiln, the angle of which blades is adjusted during rotation in such a manner that the material falling onto them in the coarse-material discharge region is diverted toward the fine-material side and the material falling onto them in the fine-material discharge region is diverted toward the coarse-material side. A drawback is that the fine material which is produced in the coarse-material discharge region is diverted to the same extent as the coarse material and that the coarse material which is produced in the fine-material discharge region is diverted to the same extent as the fine material. Since the width of the blades is small, the diverting action is also slight. Therefore, the material cannot be conveyed from the coarse-material discharge side into the fine-material discharge side (and vice-versa), but rather it is in each case only deflected slightly toward the center. Consequently, the entire discharge stream is concentrated in the center, but the division into a coarse-material side and a fine-material side is maintained within this concentrated discharge stream. Therefore, on the one hand the aim of improved mixing is not achieved, and on the other hand there is a further drawback that the material which is now produced in concentrated form in the center of the cooling grate has to be spread back over the entire width of the cooling grate by means of dedicated devices.

The invention is based on the object of more effectively making the discharge stream more uniform. It achieves this by means of the method as claimed in claim 1 or by means of the device as claimed in claim 5, with the features given in the subclaims preferably also contributing.

The invention is based on the object of making the discharge stream more uniform. It achieves this by means of the measures given in claim 1 or claim 6 and preferably the features given in the subclaims.

The invention provides for at least some of the fired material to be conveyed in the transverse direction as a function of its grain size. Therefore, not all of the fired material is conveyed from the coarse-material discharge side toward the fine-material discharge region or from the fine-material discharge region toward the coarse-material discharge region, but rather in each case only a coarse or fine fraction or parts thereof is/are subjected to this conveying. As a result, segregation is substantially eliminated. It is true that it is known to screen material emerging from a rotary kiln (U.S. Pat. No. 4,680,009), but this is in order that the fractions which are separated as a result can be supplied to different containers. The problem of how the segregation which occurs during the discharge of the material from the rotary kiln can be eliminated is not dealt with. Rather, the opposite is the objective.

This takes place before the discharge stream reaches the cooler, i.e., in the case of a grate cooler, the cooling grate or the bed of material resting on the cooling grate. Therefore, the method according to the invention takes place before the material has reached the bed of material in the cooler.

Carrying out the method according to the invention before the material reaches the cooler does not rule out the possibility of cooling taking place in direct or indirect conjunction with this method. In addition, it is possible (as is known per se) to crush the coarse material.

While the method according to the invention is being carried out, cooling takes place, at least for the purpose of cooling the equipment used for the method. This cooling can also be utilized for the controlled reduction of the temperature of the material, in particular the fine material. The cooler fine material can then be deposited on the cooling grate of the adjoining cooler before the coarse material, in order to form a protective layer which separates the cooling grate from the hot, coarse material situated above it.

The size of the proportion of material which is removed from a region and the extent to which it is conveyed into the other region is a matter for simple tests and therefore does not require any general stipulations.

An arrangement for making the fired-material discharge more uniform is distinguished by the fact that in the coarse-material discharge region a conveyor device which is directed toward the fine-material discharge region is connected upstream of the cooler and/or in the fine-material discharge region a conveyor device which is directed toward the coarse-material discharge region is connected upstream of the cooler. This conveyor device is expediently designed as a roller, the axis of which is arranged transversely with respect to the direction of the rotary kiln and therefore in the direction of the lateral extent of the discharge stream, a boundary wall being adjacent to the roller surface. The material which is situated in the wedge gap between the roller surface and the boundary wall and is too coarse to fall through the gap between roller surface and wall is subjected to a conveying action along the roller which can be produced by the inclination of the roller and/or the wall and/or by means of suitable conveyor elements on the roller surface or on the wall.

The wedge space between that side of the roller which rises as a result of the rotation and an adjacent boundary wall is particularly suitable for this purpose, since the movement of the roller surface leading out of this wedge space loosens the material. Therefore, the roller is expediently designed in such a way that the discharge stream initially comes into contact with the rising side of the roller. The discharge line of the material enters the wedge space (including the roller surface up to its apex). However, it will be understood that it can also be guided onto the descending side of the roller (if a corresponding boundary wall is provided on that side) if there is no risk of the fired material fusing together.

According to a particular feature of the invention, however, the conveyor action does not remain restricted to one side of the roller. Rather, in addition to the wedge space between the roller and a boundary wall on the rising side of the roller, a corresponding wedge space is provided on the descending side of the roller. Some of the material which has not been conveyed away or does not drop through in the wedge space which the stream reaches initially is carried over into the other wedge space by the roller, where it is processed by being conveyed and, if appropriate, crushed. In this arrangement, the processing conditions in this other wedge space differ significantly from those in the first wedge space. Firstly, the proportion of coarse material is greater. Secondly, the roller movement which draws the material into the wedge gap provides different and more intensive treatment options which can be utilized in a controlled way to convey and, if appropriate, comminute the material. The wall which is involved in the process is therefore referred to as a crusher wall.

The width of the passage between the roller surface and the boundary or crusher wall is expediently adjustable. On the one hand, it is possible for the position of the wall to be varied, while on the other hand it is also possible for the position of the roller to be varied.

The device which is formed by the roller surface and the boundary wall is expediently inclined toward the fine-material discharge region. To be more precise, the wedge space between the roller and boundary wall should be inclined in this way. This inclination may be based on the inclination of the roller and/or the inclination of the boundary wall. This inclination causes the pieces which remain in the wedge space on account of their size to migrate gradually toward the fine-material discharge side under the force of gravity. By contrast, it is possible for the fine material to drop relatively quickly between the roller and boundary wall or to be conveyed in the opposite direction in the manner which is explained below. As an alternative or in addition, the surface of the roller may be equipped with conveyor elements and/or may be formed from elements of this type. These are elevations or indentations, the flanks of which run obliquely with respect to the circumferential direction, in such a manner that in the event of their relative movement with respect to the material they exert a conveying action on this material along the roller axis, for example toward the fine-material discharge side. As an alternative or in addition, the boundary wall may also bear conveyor elements.

If the conveying action is to be brought about by means of an inclination, this inclination may be based on a conicity of the roller; in more general terms, this means that the roller diameter decreases toward the fine-material discharge side. This reduction in diameter does not need to be uniform, but rather is advantageously stepped for the purpose of economic production. This stepped design is intended to be included in the expression “conical shape” used below. The more individual pieces of the material are lifted out of the wedge gap by the rotation of the roller, the more noticeable the effect of the inclination based on the conicity of the roller and consequently the more intensive the conveying action becomes. To adjust the inclination of the arrangement, the inclination of the individual components may be adjustable. It is particularly advantageous if a plurality of closely interacting components, namely the roller and/or the boundary wall and/or the crusher wall and/or the stripper, are arranged on the same frame and this frame is adjustable.

Providing the roller with a larger diameter on the coarse-material discharge side also has the advantage that on this side the roller provides a larger and more quickly moving surface for processing the coarse material, while on the fine-material discharge side the greater tendency of the material to drop through the gap means that the density of the material is lower. If the roller is of stepped design, it may be expedient for the boundary walls also to be correspondingly stepped (as seen in the longitudinal direction of the roller). When viewed toward a plane which lies at right angles to the roller axis, the crusher wall may also be stepped, so that the step edges are able to exert a crushing action on the coarse material.

According to a particular feature of the invention, the roller has a screening lateral surface. It is of hollow design and its lateral surface contains apertures through which fine material can fall. This material then passes into the interior of the roller, the bottom surface of which, given a conical design of the roller lateral surface and an approximately horizontal position of the roller axis, drops toward the coarse-material discharge side. As a result, the fine material is conveyed toward the coarse-material discharge side. It may be expedient to allow most of the fine material to pass into the interior of the roller. In this case, only a small fine-material fraction drops through the preferably adjustable gap between roller surface and boundary wall.

To ensure that the fine material is exposed to the conveying action in the roller for a sufficiently long time and does not drop back out of the roller as easily as it entered, the webs which form the roller lateral surface may be designed in such a way that they promote penetration of the fine material into the roller but present an obstacle to the material falling out again. By way of example, they may be of large-area design and may be inclined forward and outward with respect to the radial direction, as seen in the direction of rotation. This may also be referred to as an imbricated arrangement.

To additionally loosen the fine material and to assist the conveying toward the coarse-material discharge side, conveyor elements may be installed in the interior of the roller and/or the inner circumferential surface may have profiled elements, of which the surfaces which are arranged at an angle to the circumferential direction exert a conveying action on the material toward the coarse-material discharge side.

For various reasons, it is expedient if the outer surface of the roller is rough. In this context, the term roughness is to be understood as meaning that the roller surface is equipped with projections or humps. These include, for example, the abovementioned conveyor elements, of which the surfaces which are inclined with respect to the circumferential direction exert a conveying action on the material. These also include surfaces which promote the lifting of coarse material out of the wedge space on the rising side of the roller, in order to carry this material over to the descending side of the roller. Finally, this also includes those elements which exert a crushing action on the coarse material by interacting with the crusher wall.

To prevent the material which is situated on the descending roller side, in the event of the material dropping suddenly, being pressed into the wedge gap so violently that the latter becomes blocked, the crusher wall, at least on this side, is expediently mounted resiliently, so that it is able to spring back away from the roller surface and open up the passage for the material. This may lead to a vibratory motion which is advantageous with a view to crushing the coarse material.

According to a further feature of the invention, a stripper may be arranged above the roller. This stripper is a bar which is mounted parallel to the upper surface line of the roller or a more or less continuous row of individual elements. The bar or the elements are expediently mounted resiliently, i.e. in a suspended manner. The distance of this bar or these elements from the surface of the roller is expediently adjustable. The stripping action consists in the coarse material which has been lifted on the rising side of the roller surface, particularly when unusually large amounts of material are present, being distributed uniformly over the length of the roller and thus preventing local blockage of the device. Under the stripping action, some of the material will drop back into the wedge space on the rising side of the roller and in the process will be conveyed along the roller axis toward the fine-material side. This effect can be intensified by equipping the stripper with plowshare-like plate elements which are disposed at an angle with respect to the circumferential direction. On the other hand, if the distance of the stripper from the roller surface is set appropriately, coarse pieces can be comminuted. Pieces where are smaller than the distance between the stripper and the roller surface are passed over to the descending side of the roller. It is possible for a plurality of strippers of this type to be arranged one behind the other over the circumference of the roller, expediently being at a distance from the roller surface which decreases in the direction of rotation of the roller, so that multistage comminution of the material takes place. The plurality of strippers may be mounted independently of one another or on a common pendulum axle. They can be forced into the desired distance setting from the roller surface by the force of a spring or weight. The abovementioned crusher wall on the descending side of the roller may be replaced by one or more strippers. However, it may also be provided as an additional feature.

The roller, the boundary wall, the crusher wall and/or the stripper are expediently cooled as a result of being equipped with coolant channels through which a liquid or gaseous coolant circulates. It is particularly advantageous for the coolant used to be air which is expediently allowed to emerge from the abovementioned components at locations at which intensive surface cooling is desired. In particular, it may be expedient to allow the air to flow out into the roller cavity. It can be supplied via the shaft, which is of hollow design, or shaft journals. Expediently, the air or most of the air is supplied from the fine-material side, in order to assist with conveying the fine material toward the coarse-material side. According to a further feature, it can be passed through the roller interior as a turbulent flow, so that on the one hand the cooling-air stream is in contact with the inner surface of the roller and on the other hand a cyclone effect is produced, by means of which the ultrafine material particles are separated off in the roller cavity. According to a further feature of the invention, the roller cavity can be divided into chambers by means of continuous partitions, which chambers follow one another in the circumferential direction and expediently each extend over the entire length of the roller. The cooling air may be supplied to these chambers separately, so that it is possible to take into account the different thermal loads in different circumferential regions of the roller. The cooling air escapes from the interior of the roller through the passage apertures in the roller lateral surface and therefore cools this surface particularly intensively. If the boundary wall, the crusher wall and/or the stripper have cooling-air outlet openings, these openings should open out in the direction of rotation of the roller, so that the fired material cannot be forced into these openings by the roller.

The height of the projections on the surface of the roller may be less than the width of the passage gap which is provided between the roller surface and the boundary wall or crusher wall. In many cases, preference is given to an embodiment in which the boundary walls have recesses through which the projections on the roller pass in an intermeshing manner. Firstly, this has the advantage that the height of the projections is not restricted by the side of the passage gap. Secondly, the projections and the passages exert a stripping action on one another and loosen the material, so that the material is prevented from accumulating on these parts. Moreover, in the region of the crusher wall this exerts a shearing action on the material.

Further features of the invention will emerge from the following description of exemplary embodiments. In the drawing:

FIG. 1 shows a diagrammatic view of the discharge from a rotary kiln onto a grate cooler,

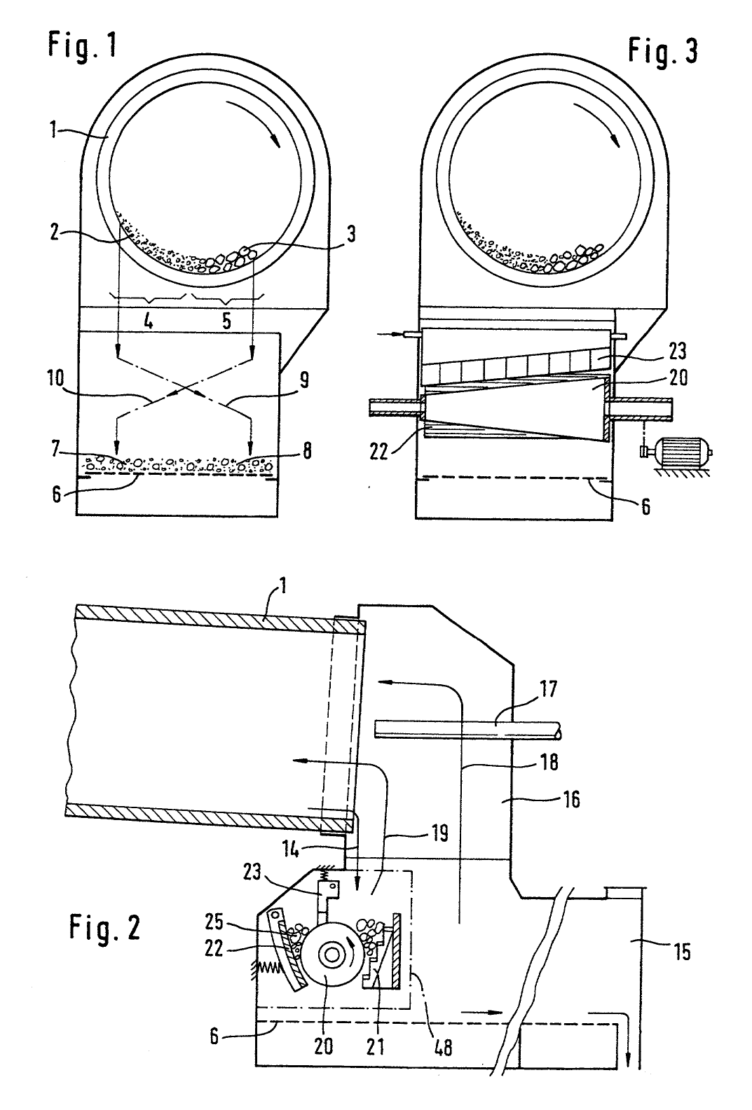

FIG. 2 shows a section through the arrangement according to the invention in the longitudinal direction of the kiln, and

FIG. 3 shows a corresponding section at right angles to that shown in FIG. 2,

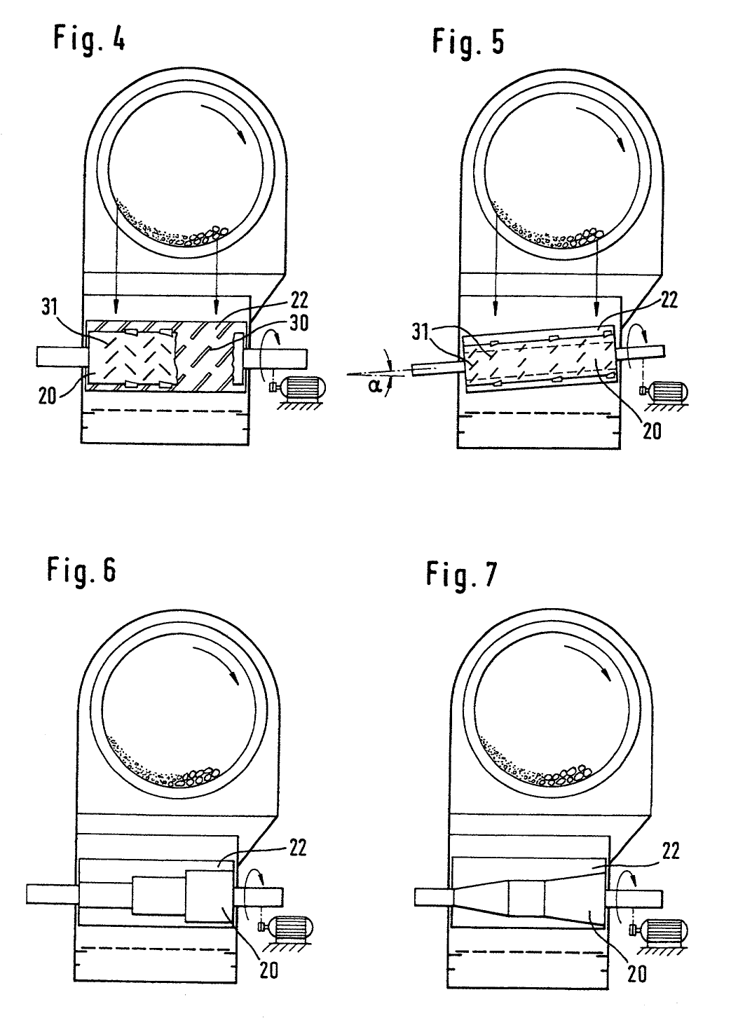

FIGS. 4 to 7 show different roller arrangements,

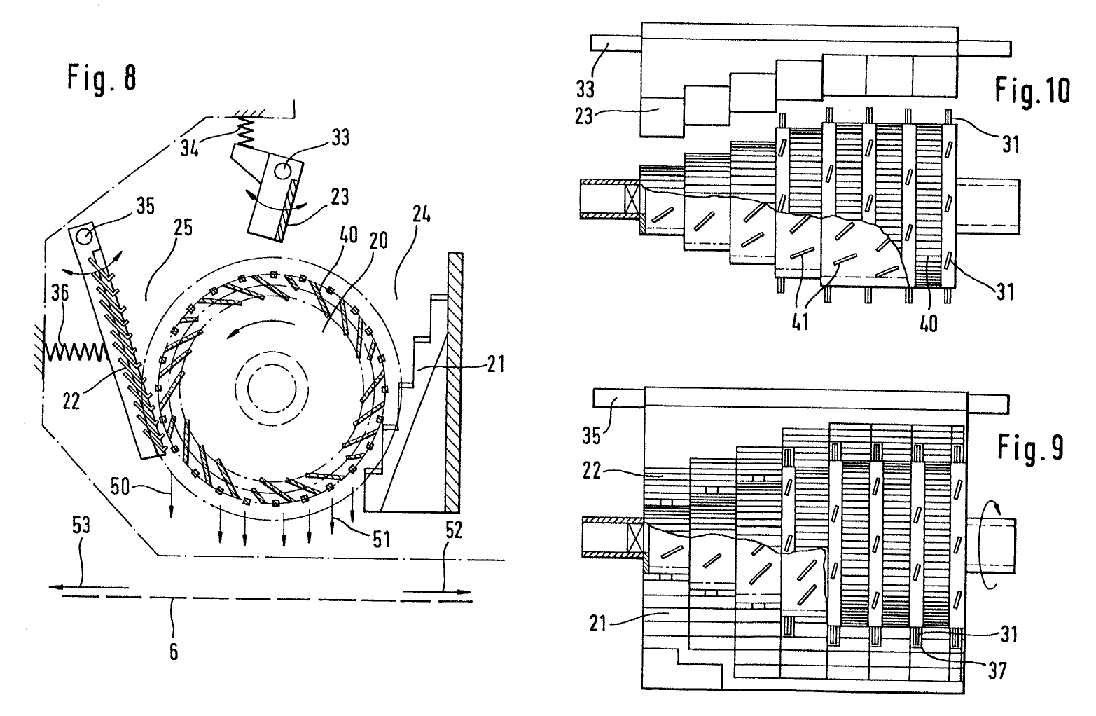

FIGS. 8, 9 and 10 show a section, a plan view and a side view of an exemplary embodiment, and

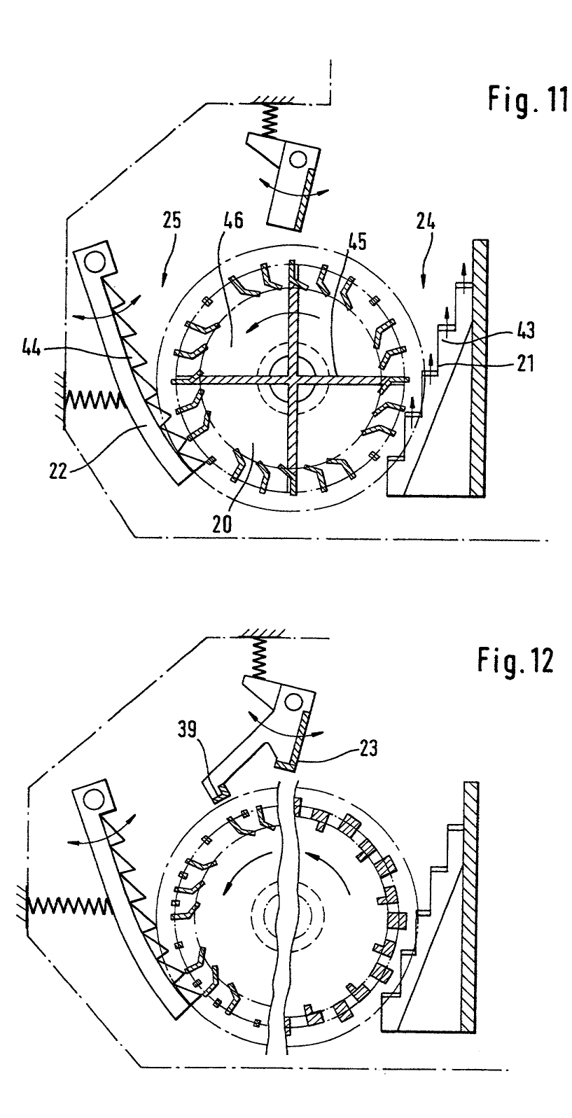

FIGS. 11 and 12 show sectional views in accordance with FIG. 8 through design variants.

The material which collects in the outlet of the rotary kiln 1 is distributed differently over the width according to its grain size. The fine material 2 is carried along further by the rotation of the kiln than the coarse material 3. Within the discharge stream which is indicated by arrows in FIG. 1, therefore, the fine material is predominantly in the fine-material discharge region 4, while the coarse material is predominantly in the coarse-material discharge region 5. Therefore, in a conventional design, the fine material is predominantly on the side 7 of the cooling grate 6, while the coarse material is predominantly on the side 8 of the cooling grate 6.

The principle of the invention consists in conveying a significant portion of the fine material out of the fine-material discharge region 4 into the coarse-material discharge region 5 or into the region 8 of the cooler and/or in conveying a significant portion of the coarse material out of the coarse-material discharge region 5 into the fine-material discharge region 4 or onto the other side 7 of the cooler 6, in the direction indicated by the arrows 9 and 10. The intention is in this way to substantially eliminate the segregation of the coarse material and fine material which has been produced by the kiln. The grain size spectrum is to be made more uniform over the width of the bed of material 7, 8.

To do this, a transverse conveyor is used, the arrangement of which can be seen from FIG. 2. The rotary kiln 1 opens out in the cooler inlet housing 16, which also contains the burner 17 for the kiln 1. The kiln discharges the material into the cooler in the direction of the arrow 14, the cooler containing the cooling grate 6 inside a cooler housing 15. The heated waste air from the cooler is fed to the furnace 1 as secondary air in the direction indicated by the arrow 18. It can also be supplied to the furnace preheater system.

The transverse conveyor is part of the device according to the invention, specifically the part which lies inside the frame 48 shown by dot-dashed lines in FIG. 2. In all the examples illustrated, the transverse conveyor comprises at least one roller 20 which is arranged approximately horizontally, at right angles to the direction of the furnace, and is driven in rotation, and a boundary wall 21, which is adjacent to the rising side of the roller. Expediently, there is also a crusher wall 22 on the opposite side and a crusher arrangement which is situated above the roller 20 and is illustrated in the form of a crusher bar 23.

The rising side of the roller 20 and the boundary wall 21 form a wedge space 24, which is arranged in such a way that the discharge stream coming out of the kiln 1 enters this space. The discharged material collects in the wedge space 24. Some of the fine material falls through the gap formed between the roller 20 and the wall 21 and thus passes directly onto the cooling grate 6. As explained below, a further, generally larger, proportion of the fine material passes through openings in the roller surface, into the interior of the roller 20, in the process being conveyed toward the coarse-material side, and is then discharged from the roller onto the cooling grate 6.

As described in more detail below, the coarse material is carried along by the moving roller surface and in the process is conveyed toward the fine-material side. As soon as it enters the gap beneath the crusher bar 23, it passes into the wedge space 25 between the descending roller surface and the crusher wall 22, where it is comminuted and, if appropriate, conveyed toward the fine-material side before it drops between the roller surface and the crusher wall onto the cooling grate.

To allow the conveying action on the surface of the roller to take place in the circumferential direction from the wedge space 24 to the wedge space 25, the roller surface is provided with projections which carry along the material. To bring about an axial conveying direction in the wedge spaces 24 and 25, it is possible to use different structural means. The example given in FIG. 3 shows that the diameter of the roller decreases from the coarse-material side toward the fine-material side. Consequently, the surface of the roller drops down toward one side in the region of the wedge spaces, so that the material tends to move in this direction. As shown in FIG. 4, the crusher wall 22 is provided with conveyor elements 30. These may be plate-like, wing-like or strip-like protrusions which are inclined with respect to the circumferential direction of the roller 20 in such a manner that as a result of the relative movement a conveying pulse toward the fine-material side is produced. Corresponding conveyor elements 30 may also be provided on the boundary wall 21. The outer roller surface is likewise provided with projections 31 and/or consists of elements of this type, which may likewise be arranged in such a way that they impart an axial conveying pulse. However, this is not imperative. FIG. 4 shows opposite inclinations of these projections on the roller 20, which therefore overall do not on their own bring about an axial conveying action of this type. Their purpose is to transfer the coarse material out of the wedge space 24 into which it has been discharged into the wedge space 25 as a result of the rotation of the roller, it being possible at the same time to exert a comminuting action.

In the exemplary embodiment shown in FIG. 5, the projections 31 on the surface of the roller 20 are inclined in the direction of the desired conveying. Moreover, the roller 20 and the associated boundary and crusher walls 21, 22 are inclined by the angle α with respect to the horizontal. They drop downward from the coarse-material side toward the fine-material side, so that a conveying pulse in the direction from the coarse-material side toward the fine-material side is exerted on the material which is situated on the roller or in the wedge spaces 24, 25. If appropriate, the angle α may be adjustable, in order to modify the intensity of the conveying pulse.

In the exemplary embodiments shown in FIGS. 6 and 7, the conical shape of the roller is replaced by a stepped reduction in diameter and by a partially conical, partially stepped reduction in diameter, respectively, from the coarse-material side to the fine-material side. The effect is in each case similar to that of a conical roller. However, this design may facilitate production. It will be understood that the boundary wall 21 and the crusher wall 22, if present, are adapted to the changing diameter of the roller 20. This can be seen in FIG. 9.

If it is desired to comminute the coarse material, a crusher bar 23 may be provided above the roller 20. In the exemplary embodiment shown in FIGS. 8 and 10, a single crusher bar 23 is provided, which is suspended so as to oscillate about the axis 33, which is parallel to the roller axis, and is forced into the position illustrated, in which it is at its closest to the roller surface, by the force of gravity and/or spring force 34. While the coarse material is being carried out of the wedge space 24 towards the wedge space 25 by the movement of the roller surface, it can be comminuted as a result of the roller surface interacting with the crusher bar 23. The crusher bar is adapted to the shape of the roller 20, in order to be at a suitable distance from the roller surface throughout. It will be understood that its form may vary depending on the type of crushing action which is desired of it; by way of example, FIG. 12 shows a variant in which a second crusher bar 39 is rigidly connected, with an offset in the circumferential direction of the roller 20, to the crusher bar 23. During the pendulum movement which is brought about by the passage of material, the crusher bar 23 moves with respect to the roller surface predominantly in the circumferential direction of this surface, while the crusher bar 39 moves transversely to this direction, with the result that a different comminuting action is achieved.

Further comminution is brought about by the interaction of the roller surface with the crusher wall 22, which is suspended in the manner of a pendulum about the axis 35, which is parallel to the roller axis, and is displaced toward the roller surface by spring force 36.

The projections 31 on the roller 20 are also involved in the crushing action. The higher the projections, the greater their action. To allow the boundary wall and/or the crusher wall 22 nevertheless to be as close as desired to the remaining surface of the roller, these walls—as shown in FIG. 9—are provided with cutouts 37 for the projections 31 to pass through. When the projections 31 pass through the boundary wall 21 or crusher wall 22, a shearing action is exerted on the material.

The roller surface is designed to be permeable to fine material. To be precise, the surface is provided with passage apertures which allow the entry of material of such a grain size, which is to be subjected to a conveying action toward the coarse-material side. In accordance with FIGS. 8, 11 and 12, the roller surface is largely formed by lamellae or bars 40, between which the apertures are situated. They may be designed differently, as shown in FIGS. 8, 11 and 12, the latter figure illustrating different design options on both sides. During the relative movement of the roller surface with respect to the boundary wall 21, the fine material is forced into the passages and therefore passes into the interior of the roller before the conveyor elements which are directed toward the fine-material side on the roller outer surface are able to exert any significant influence on it. The penetration of the fine material into the roller can be increased further by inclining the lamellae 40, from the outside inward, backward with respect to the radius.

Moreover, this inclination of the lamellae 40 has the property of inhibiting emergence of the fine material from the roller. Therefore, the inclination of the lamellae with respect to the radius and their distance from one another will be determined on the basis of tests in such a way that the fine material on the one hand remains in the roller for a sufficiently long time to be conveyed sufficiently far toward the coarse-material side without, on the other hand, causing a blockage within the roller. The angular position and size of the lamellae and the distance between the lamellae do not have to be constant over the length of the roller. Particularly in the case of a stepped design of the roller as shown in FIGS. 9 and 10, it is recommended for these parameters to be selected differently within the individual diameter sections. In this case, it is expedient for the emergence of the fine material from the interior of the roller to be inhibited to a greater extent at the fine-material end of the roller than at the coarse-material side. It is not generally necessary to inhibit emergence on the coarse-material side of the roller, since residual emptying of the fine material is required in that area.

The conveying in the interior of the roller may take place in the same way as that described above for the conveying action on the outer side and by means of projections, wings or guide plates 41 which are inclined with respect to the axial direction, rotate with the roller and thus exert a conveying pulse on the material situated inside the roller. FIGS. 9 and 10 are shown as a partially cut-away view, so that it is possible to see the conveying wings 41 which are provided on the inner side of the roller.

However, it is also possible to provide other conveyor means inside the roller, for example chutes which are arranged in a stationary position. One or more chutes of this type may also be provided beneath the roller, at the location at which the fine material leaves the roller. Finally, it is possible to use the inclination of the inner surface of the roller for the axial conveying. On the one hand, this takes place with a conical roller shape (FIG. 3). On the other hand, the entire roller may be inclined from the fine-material side toward the coarse-material side, i.e. in the opposite direction to that shown in FIG. 5.

It is expedient for the device to be cooled. Coolant channels may pass through the parts of the roller 20, the boundary wall 21, the crusher wall 22 and/or the crusher bar 23. Water cooling may be considered for regions which are subject to particularly high loads. However, air cooling is generally more expedient, having the advantage that, after leaving the structural parts which are to be cooled, the cooling air also cools the material and can then be fed to the kiln in the direction indicated by the arrow 19 (FIG. 2). As shown in FIG. 11, the boundary wall 21 and the crusher wall 22 are constructed in stepped or sawtooth form from air-guiding chambers 43, 44, outlet openings from which lead predominantly into the region of the wedge spaces 24, 25. The air-outlet openings should not run toward the direction of movement of the adjacent roller surface, so that they do not become blocked. Therefore, in the device shown in FIG. 12, the air-outlet directions are directed upward in the steps of the boundary wall 21 and downward in those of the crusher wall 22.

The crusher bar may likewise be designed as an air-guiding chamber. The same applies to the lamellae, webs or bars which form the surface of the roller. However, it is structurally simpler and therefore preferable if, instead or in addition, cooling air is fed to the interior of the roller through its shaft. It is possible for cooling-air guide devices, which deflect the cooling air predominantly onto the material in the conveying direction, in order to assist with the conveying movement of the material, to be provided inside the roller.

Since the temperature load on the roller varies in different circumferential regions, it is possible to provide internal fittings which divert the cooling air predominantly into those regions in which the demand for cooling is most intensive. These fittings may be stationary cooling-air guide devices. The invention preferably uses embodiments such as those shown in FIG. 11 in which the roller 20 includes walls 45 which are fixedly connected to it and divide the interior into a plurality of chambers 46 which follow one another in the circumferential direction and to which the cooling air can be supplied through the shaft, selectively and alternately during rotation. In this way it is possible, for example, to ensure that in each case those chambers which form an upper circumferential part, facing toward the incoming hot material, are preferentially supplied with cooling air.

Conveying the fine material has proven significantly more effective than conveying the coarse material. On occasion, therefore, it may be justifiable to dispense with axial conveying of the coarse material in favor of conveying only the fine material into the coarse-material discharge region.

FIG. 2 shows the transverse conveyor device 20 to 23 according to the invention, which is surrounded by a dot-dashed line 48. This indicates that these parts form a structural unit. By way of example, they are arranged on a common frame. This unit can be removed in its entirety from the cooler housing for maintenance purposes. If appropriate, it may also be substituted in its entirety by a different unit.

It is clear from the above explanations that from the device illustrated in FIG. 8, the coarse material is discharged predominantly on that side of the roller at which the crusher wall 22 is situated. This is indicated by the arrows 50. By contrast, the fine material is discharged predominantly on the other side and from the lower region of the roller, in the direction indicated by the arrows 51. If the conveying direction of the grate 6 corresponds to the arrow 52, the fine material 51 therefore passes onto the grate after the coarse material. In the bed of material, the coarse material is largely beneath the fine material. It is therefore reached directly by the cooling air flowing out of the grate. This may be expedient, since the coarse material cools more slowly.

On the other hand, in other cases it is desirable for the material which has already been cooled to a greater extent in the region of the roller 20 to form a protective layer between the hotter coarse material and the grate. In this case, the device according to the invention will be arranged in such a manner with respect to the grate that the conveying direction is that indicated by the arrow 53. In this arrangement, the fine material passes onto the grate before the coarse material and therefore lies beneath the coarse material in the bed of material.

1. A method for making the fired-material discharge stream from a rotary kiln more uniform upstream of a cooler, in which at least some of the fired material is conveyed out of the coarse-material discharge region toward the fine-material discharge region and/or at least some of the fired material is conveyed out of the fine-material discharge region toward the coarse-material discharge region before it reaches the cooler, wherein the fired material is screened and at least one fraction is subjected to lateral conveying.

2. The method as claimed in claim 1, wherein the material which is produced in the coarse-material discharge region and/or the coarse material which is formed during screening is crushed.

3. The method as claimed in claim 1 or 2, wherein cooling takes place while this method is being carried out.

4. The method as claimed in claim 3, wherein the cooled fine material is passed onto the cooling grate of the cooler before the coarse material.

5. An arrangement for making the fired-material discharge from a rotary kiln to a cooler more uniform, having a conveyor device (20), which in the coarse-material discharge region (5) is directed toward the fine-material discharge region (4) and/or in the fine-material discharge region (4) is directed toward the coarse-material discharge region (5) and which is connected upstream of the cooler (6), wherein the conveyor device is formed by a roller (20), which is driven in rotation transversely with respect to the conveying direction, and a boundary wall (21) which is adjacent to the roller, which elements are provided with conveyor elements and/or are inclined in the conveying direction.

6. The arrangement as claimed in claim 5, wherein the roller surface is formed by a belt which runs around a plurality of diverting axles, in particular a slat conveyor.

7. The arrangement as claimed in claim 5 or 6, wherein the outer upper-side roller surface is inclined toward the fine-material discharge region (4).

8. The arrangement as claimed in claim 7, wherein the diameter of the roller (20) decreases toward the fine-material discharge region (4).

9. The arrangement as claimed in one of claims 5 to 8, wherein the reduction in diameter is stepped.

10. The arrangement as claimed in one of claims 5 to 9, wherein the boundary wall (21) is inclined in the conveying direction.

11. The arrangement as claimed in one of claims 5 to 10, wherein the surface(s) of the roller (20) which promote(s) the conveying has/have conveyor elements.

12. The arrangement as claimed in one of claims 5 to 11, wherein the boundary wall (21) is adjacent to that side of the roller which rises in the rotary movement, and the discharge line (14) of the material lies in the wedge-shaped space (24) which is formed between the two components.

13. The arrangement as claimed in one of claims 5 to 12, wherein the roller (20) and the boundary wall (21) enclose a passage for fine material.

14. The arrangement as claimed in claim 13, wherein the width of the passage is adjustable.

15. The arrangement as claimed in one of claims 5 to 14, wherein the roller (20) has a screening lateral surface.

16. The arrangement as claimed in claim 15, wherein the inner, lower roller surface is inclined toward the coarse-material discharge region.

17. The arrangement as claimed in one of claims 5 to 16, wherein the passage openings in the roller lateral surface are separated by lamellae (40) which are inclined forward and outward in the direction of rotation.

18. The arrangement as claimed in one of claims 5 to 17, wherein the outer roller surface is rough.

19. The arrangement as claimed in one of claims 5 to 18, wherein a crusher wall (22) is arranged next to the descending side of the roller.

20. The arrangement as claimed in claim 18 or 19, wherein the roller (20) and the boundary wall (21) or crusher wall (22) have projections (31) and recesses (37) which mesh with one another.

21. The arrangement as claimed in one of claims 5 to 20, wherein the crusher wall (22) is resilient under the force of a spring or weight (36).

22. The arrangement as claimed in one of claims 5 to 21, wherein at least one stripper (23) is arranged above the roller (20).

23. The arrangement as claimed in one of claims 5 to 22, wherein the roller (20), the boundary wall (21), the crusher wall (22) and/or the stripper (23) include cooling channels.

24. The arrangement as claimed in claim 23, wherein the coolant is air and at least some of this air flows out into the roller cavity.

25. The arrangement as claimed in claim 23 or 24, wherein air-guiding devices for assisting the conveying action are arranged inside the roller (20).

26. The arrangement as claimed in claim 25, wherein turbulence is imparted to the cooling air.

27. The arrangement as claimed in one of claims 24 to 26, wherein the roller interior is divided into chambers (46) which follow one another in the circumferential direction and can admit air separately.

28. The arrangement as claimed in one of claims 24 to 27, wherein the blower apertures in the boundary wall (21) and/or the crusher wall (22) and/or the stripper (23) open out in the direction of rotation of the roller.

29. The arrangement as claimed in one of claims 5 to 28, wherein the roller (20) is mounted outside the cooler housing (15).

30. The arrangement as claimed in one of claims 5 to 29, wherein the inclination (α) of the roller axis is adjustable.

31. The arrangement as claimed in claim 30, wherein the bearing of the roller (20) and/or the boundary wall (21) and/or the crusher wall (22) and/or the stripper (23) is supported by a common frame (48), and the latter is adjustable.

32. The arrangement as claimed in one of claims 5 to 31, wherein the rotational speed of the roller is adjustable.

33. The arrangement as claimed in one of claims 5 to 32, wherein the surface(s) of the roller (20) has/have conveyor elements (31).

34. The arrangement as claimed in one of claims 5 to 33, wherein the fine material drops directly onto the cooling grate (6) of the cooler and the coarse-material discharge from the roller (20) lies behind it, as seen in the conveying direction of the cooling grate.

35. The arrangement as claimed in one of claims 19 to 34, wherein the roller (20) can be moved out of the cooler housing (15) together with the crusher wall (21).
